(19) United States
(12) Patent Application Publication
(10) Pub. No.: US 2022/0033112 A1
(43) Pub. Date: Feb. 3, 2022

(54) Phase change separators for thermal gas generators

(71) Applicant: John A. Bognar, Belgrade, MT (US)

(72) Inventor: John A. Bognar, Belgrade, MT (US)

(21) Appl. No.: 17/390,825

(22) Filed: Jul. 30, 2021

Related U.S. Application Data
(60) Provisional application No. 63/059,158, filed on Jul. 30, 2020.

(51) Int. Cl. B64G 1/64; C06D 5/06

(52) U.S. Cl. CPC B64G 1/645; C06D 5/06

(57) ABSTRACT

Provided are devices for generating a desired gas or mixture of gases by thermally decomposing a gas-generating composition (e.g. a metal hydride or polymer) using the thermal energy generated by reaction of a heat-generating composition (e.g. a thermite mixture), and methods of making and using such devices. The devices include phase-changing separators, i.e. separators that at least partially melt, vaporize, or sublimate as a result of the thermal energy generated by the heat-generating composition.

### CROSS-REFERENCE TO RELATED APPLICATION

This application claims the benefit of priority under 35 U.S.C. § 119(e) to U.S. Provisional Patent Application 63/059,158, filed 30 Jul. 2020, the entirety of which is incorporated herein by reference.

### FIELD

This disclosure relates generally to separators for thermal gas generator devices, and particularly to separators that are configured to at least partially melt, vaporize, or sublimate during reaction of the heat-generating and/or pyrotechnic composition of the thermal gas generator device.

### BACKGROUND

In many applications, inflatable articles, i.e. articles that can be inflated with a gas, possess several advantages over rigid structures of the same type. Among these advantages are that an inflatable article can be stored in a small space when not inflated, and that inflatable articles can often achieve the same function as rigid counterparts for a fraction of the mass needed. These advantages are crucial considerations in many embodiments, but are particularly important regarding articles or structures adapted for use on aircraft, on spacecraft, in Earth's atmosphere, and in outer space, given that the cost and complexity of launching such articles and structures aboard aircraft or spacecraft can be highly sensitive to the mass and/or volume of the article or structure prior to use.

Finding appropriate devices, methods, and systems to deliver the gas needed to inflate an inflatable structure can often pose various challenges, however. The gas must be generated and delivered to the inflatable article quickly, often in very large quantities; in some aeronautical and astronautical applications, design specifications may call for the production of hundreds of liters of inflation gases in a matter of minutes or even seconds. To accomplish this by conventional means would typically require a housing or tank having substantial mass and volume, which for the reasons previously discussed is often not feasible aboard aircraft or spacecraft and/or in the atmosphere or space. Other applications may require the production of inflation gases in a remote area where it is impractical or impossible to transport tanks or cylinders of gas or to set up conventional gas generators, and in some cases a single person may be required to physically transport the device or system. In all of these applications, as well as others, it is essential to provide compact, lightweight gas delivery devices and systems.

Previous gas generator devices that have relied on pyrotechnic or heat-generating compositions, such as thermite mixtures, to decompose a metal hydride and/or a polymer to quickly deliver large volumes of gases may suffer from several additional drawbacks. One such drawback is the difficulty of bringing the thermite slag or reaction products into direct contact with the gas-generating reactant while also keeping the thermite mixture and the gas-generating reactant separated during manufacture or storage. Another such drawback is that it can be difficult, when the thermite slag/reaction products come into direct contact with the gas-generating reactant, to prevent gases evolved from the gas-generating material from consuming oxygen in the generator (e.g. by reacting with oxygen or metal oxides in the thermite composition), thereby quenching the thermite mixture and prematurely halting the generator.

There is thus a need in the art for devices, methods, and systems for generating and delivering a desired gas, or mixture of gases, quickly and from a very small mass and volume. It is further advantageous for such devices, methods, and systems to generate and deliver the gas quickly and in large quantities, while still being suitable for use in challenging environments (the upper atmosphere, space, rugged or remote terrain, etc.). It is still further advantageous for such devices, methods, and systems to enable direct contact between a heat-generating composition and a gas-generating composition during reaction while keeping these compositions separated during manufacture and storage, and to prevent or mitigate premature quenching of the reaction due to reactions of the product gas(es) with oxygen or metal oxides in the generator.

### SUMMARY

Embodiments and configurations of the present disclosure can address these and other needs.

In aspects of the present disclosure, a device comprises at least one separator; at least one thermal compartment, in contact with the at least one separator, containing a pyrotechnic composition and an igniter; and at least one gas generating compartment in contact with the at least one separator, wherein the at least one separator is positioned between and mutually isolates the thermal and gas generating compartments, wherein the at least one separator is configured to undergo a phase change, using heat generated by a reaction of the pyrotechnic composition.

In aspects of the present disclosure, a device comprises at least one separator; at least one thermal compartment; and at least one gas generating compartment, wherein the at least one separator (i) is in contact with the thermal and gas generating compartments; (ii) is positioned between and mutually isolates the thermal and gas generating compartments; and (iii) wherein the at least one thermal compartment comprises a pyrotechnic composition and an igniter, wherein the at least one separator is configured to undergo a phase change, using heat generated by a reaction of the pyrotechnic composition.

In aspects of the present disclosure, a device comprises a metal hydride; at least one thermal compartment; and at least one gas generating compartment, wherein the thermal and gas generating compartments are mutually isolated and separated and are in contact with each other via at least one separator, wherein the at least one gas generating compartment contains the metal hydride, wherein the at least one thermal compartment comprises a pyrotechnic composition and an igniter, wherein the at least one separator is positioned between and mutually isolates the pyrotechnic composition and the metal hydride, and wherein the at least one separator is configured to undergo a phase change, using heat generated by a reaction of the pyrotechnic composition.

In embodiments, the at least one separator may comprise a metal.

In embodiments, the at least one separator may comprise at least first and second layers, wherein a material of the first layer is different from a material of the second layer.

In embodiments, the at least one separator may comprise a mixture of at least two different materials.

In embodiments, the phase change may be melting.

In embodiments, the phase change may be vaporization.

In embodiments, the phase change may be sublimation.

In embodiments, the metal hydride may be lithium aluminum hydride (LiAlH₄).

In embodiments, the pyrotechnic composition may be a thermite composition comprising a mixture of a metal fuel and a metal oxide oxidizer that undergoes an exothermic reduction-oxidation reaction when ignited.

In embodiments, the at least one separator may comprise two or more separators.

In embodiments, the at least one thermal compartment may comprise two or more thermal compartments.

In embodiments, the at least one gas generating compartment may comprise two or more gas generating compartments.

In embodiments, the at least one separator may be configured such that at least a portion of the pyrotechnic composition or its reaction products and at least a portion of a metal hydride within the gas generating compartment are in direct physical contact following the phase change.

In aspects of the present disclosure, a process comprises initiating, in at least one thermal compartment, reaction of a pyrotechnic composition consisting essentially of a metal oxide and a metal to release thermal energy; causing at least one separator to undergo a phase change, using thermal energy released by the reaction, wherein the at least one separator is in thermal contact with, is positioned between, and mutually isolates the thermal compartment and a gas generating compartment prior to the initiating step; and decomposing, using thermal energy released by the reaction and transferred to the at least one gas generating compartment, at least some of the one or more metal hydrides to release hydrogen gas.

In embodiments, the at least one separator may comprise a metal.

In embodiments, the at least one separator may comprise at least first and second layers, wherein a material of the first layer is different from a material of the second layer.

In embodiments, the at least one separator may comprise a mixture of at least two different materials.

In embodiments, the phase change may be melting.

In embodiments, the phase change may be vaporization.

In embodiments, the phase change may be sublimation.

In embodiments, the one or more metal hydrides may comprise lithium aluminum hydride (LiAlH₄).

In embodiments, the at least one separator may comprise two or more separators.

In embodiments, the at least one thermal compartment may comprise two or more thermal compartments.

In embodiments, the at least one gas generating compartment may comprise two or more gas generating compartments.

In embodiments, the at least one separator may be configured such that at least a portion of the pyrotechnic composition or its reaction products and at least a portion of one or more metal hydrides within at least one gas generating compartment are in direct physical contact following the phase change.

In aspects of the present disclosure, an inflatable device comprises an inflatable article; a self-contained hydrogen generator a) interconnected to the inflatable article; b) configured to inflate the inflatable article; and c) having at least one thermal separator positioned between and in thermal contact with i) at least one thermal compartment containing a thermite composition comprising a metal oxide and metal; and ii) at least one gas generating compartment containing a metal hydride; an igniter configured to ignite the thermite; and a data collection module that is configured to collect data using a microprocessor executable set of instructions stored in a computer readable media for determining one or both of atmospheric and terrestrial activities or conditions, wherein the at least one thermal separator is configured to undergo a phase change, using heat generated by a reaction of the thermite composition.

In aspects of the present disclosure, an inflatable device comprises a self-contained hydrogen generator a) interconnected to an inflatable article; b) configured to inflate the inflatable article; and c) having at least one thermal separator positioned between and in thermal contact with i) at least one thermal compartment containing a thermite composition comprising a metal oxide and metal; and ii) at least one gas generating compartment containing a metal hydride; and an igniter configured to ignite the thermite composition; and a data collection module that collects data using a microprocessor executable set of instructions stored in a computer readable media for determining one or both of atmospheric and terrestrial activities or conditions, wherein the at least one thermal separator is configured to undergo a phase change, using heat generated by a reaction of the thermite composition.

In embodiments, the at least one thermal separator may comprise a metal.

In embodiments, the at least one thermal separator may comprise at least first and second layers, wherein a material of the first layer is different from a material of the second layer.

In embodiments, the at least one thermal separator may comprise a mixture of at least two different materials.

In embodiments, the phase change may be melting.

In embodiments, the phase change may be vaporization.

In embodiments, the phase change may be sublimation.

In embodiments, the metal hydride may be lithium aluminum hydride (LiAlH₄).

In embodiments, the at least one separator may comprise two or more separators.

In embodiments, the at least one thermal compartment may comprise two or more thermal compartments.

In embodiments, the at least one gas generating compartment may comprise two or more gas generating compartments.

In embodiments, the at least one separator may be configured such that at least a portion of the thermite composition or its reaction products and at least a portion of the metal hydride are in direct physical contact following the phase change.

In aspects of the present disclosure, a gas generator device comprises at least one thermal compartment, containing a heat-generating composition; at least one gas generating compartment, containing a polymer; and at least one separator in contact with the thermal and gas generating compartments, wherein the at least one separator is configured to undergo a phase change, using heat generated by a reaction of the heat-generating composition.

In embodiments, the at least one separator may comprise a metal.

In embodiments, the at least one separator may comprise at least first and second layers, wherein a material of the first layer is different from a material of the second layer.

In embodiments, the at least one separator may comprise a mixture of at least two different materials.

In embodiments, the phase change may be melting.

In embodiments, the phase change may be vaporization.

In embodiments, the phase change may be sublimation.

In embodiments, the polymer may be selected from the group consisting of polyethylene, polypropylene, polystyrene, trioxane, polyoxymethylene, and combinations and mixtures thereof.

In embodiments, the heat-generating composition may be a thermite composition comprising a mixture of a metal fuel and a metal oxide oxidizer that undergoes an exothermic reduction-oxidation reaction when ignited by heat.

In embodiments, the at least one separator may comprise two or more separators.

In embodiments, the at least one thermal compartment may comprise two or more thermal compartments.

In embodiments, the at least one gas generating compartment may comprise two or more gas generating compartments.

In embodiments, the at least one separator may be configured such that at least a portion of the thermite composition or its reaction products and at least a portion of the metal hydride are in direct physical contact following the phase change

In aspects of the present disclosure, a method for generating at least one product gas comprises initiating reaction of a heat-generating composition to release thermal energy; using a portion of that thermal energy to cause a phase change in at least one separator positioned between the heat-generating composition and a polymer; and decomposing, with thermal energy released by the reaction and transferred to the polymer, at least some of the polymer to release the at least one product gas.

In embodiments, the at least one separator may comprise a metal.

In embodiments, the at least one separator may comprise at least first and second layers, wherein a material of the first layer is different from a material of the second layer.

In embodiments, the at least one separator may comprise a mixture of at least two different materials.

In embodiments, the phase change may be melting.

In embodiments, the phase change may be vaporization.

In embodiments, the phase change may be sublimation.

In embodiments, the polymer may be selected from the group consisting of polyethylene, polypropylene, polystyrene, trioxane, polyoxymethylene, and combinations and mixtures thereof.

In embodiments, the heat-generating composition may be a thermite composition comprising a mixture of a metal fuel and a metal oxide oxidizer that undergoes an exothermic reduction-oxidation reaction when ignited by heat.

In embodiments, the at least one separator may comprise two or more separators.

In embodiments, the at least one separator may be configured such that at least a portion of the heat-generating composition or its reaction products and at least a portion of the polymer are in direct physical contact following the phase change.

In aspects of the present disclosure, a device comprises at least one separator, at least a portion of which can undergo a phase change under conditions occurring in the device; at least one thermal compartment, in contact with a first surface of the at least one separator, comprising a pyrotechnic composition; and at least one gas generating compartment, containing a metal hydride, in contact with a second surface of the at least one separator, wherein the at least one separator is positioned between the first and second compartments, wherein at least a portion of the at least one separator is configured to undergo a phase change, using heat generated by a reaction of the pyrotechnic composition.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the pyrotechnic composition may be a thermite composition comprising a mixture of a metal fuel and a metal oxide oxidizer that undergoes an exothermic reduction-oxidation reaction when ignited by heat.

In embodiments, the at least one separator may be configured such that at least a portion of the pyrotechnic composition or its reaction products and at least a portion of the metal hydride are in direct physical contact following the phase change.

In embodiments, the device may further comprise an igniter, configured to ignite the pyrotechnic composition.

In aspects of the present disclosure, a process comprises initiating, in at least one thermal compartment, reaction of a pyrotechnic composition consisting essentially of a metal oxide and a metal to release thermal energy; causing at least a portion of at least one separator to undergo a phase change, using thermal energy released by the reaction; and decomposing, using the thermal energy released by the reaction, at least some of one or more metal hydrides within at least one gas generating compartment to release hydrogen gas.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the at least one separator may be configured such that at least a portion of the pyrotechnic composition or its reaction products and at least a portion of the one or more metal hydrides are in direct physical contact following the phase change.

In aspects of the present disclosure, an inflatable device comprises an inflatable article; and a self-contained hydrogen generator a) interconnected to the inflatable article; b) configured to inflate the inflatable article; and c) having at least one thermal separator positioned between and in thermal contact with i) at least one thermal compartment containing a thermite composition comprising a metal oxide and metal; and ii) at least one gas generating compartment containing a metal hydride, wherein at least a portion of the at least one thermal separator is configured to undergo a phase change, using heat generated by a reaction of the thermite composition.

In embodiments, the at least one thermal separator may comprise a metal.

In embodiments, the at least one thermal separator may comprise at least first and second layers, and a material of the first layer may be different from a material of the second layer.

In embodiments, the at least one thermal separator may comprise a mixture of at least two different materials.

In embodiments, the at least one separator may be configured such that at least a portion of the thermite composition or its reaction products and at least a portion of the metal hydride are in direct physical contact following the phase change.

In embodiments, the inflatable device may further comprise an igniter, configured to ignite the thermite composition.

In aspects of the present disclosure, a gas generator device comprises at least one thermal compartment, containing a heat-generating composition; at least one gas generating compartment, containing a polymer; and at least one separator in contact with the thermal and gas generating compartments, wherein at least a portion of the at least one separator is configured to undergo a phase change, using heat generated by a reaction of the hat-generating composition.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the polymer may be selected from the group consisting of polyethylene, polypropylene, polystyrene, trioxane, polyoxymethylene, and combinations and mixtures thereof.

In embodiments, the heat-generating composition may be a thermite composition comprising a mixture of a metal fuel and a metal oxide oxidizer that undergoes an exothermic reduction-oxidation reaction when ignited by heat.

In embodiments, the at least one separator may be configured such that at least a portion of the heat-generating composition or its reaction products and at least a portion of the polymer are in direct physical contact following the phase change.

In aspects of the present disclosure, a method for generating at least one product gas comprises initiating reaction of a heat-generating composition to release thermal energy; using a portion of the thermal energy to cause a phase change in at least a portion of at least one separator positioned between the heat-generating composition and a polymer; and decomposing, with thermal energy released by the reaction and transferred to the polymer, at least some of the polymer to release the at least one product gas.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the polymer may be selected from the group consisting of polyethylene, polypropylene, polystyrene, trioxane, polyoxymethylene, and combinations and mixtures thereof.

In embodiments, the heat-generating composition may be a thermite composition comprising a mixture of a metal fuel and a metal oxide oxidizer that undergoes an exothermic reduction-oxidation reaction when ignited by heat.

In embodiments, the at least one separator may be configured such that at least a portion of the heat-generating composition or its reaction products and at least a portion of the polymer are in direct physical contact following the phase change.

In aspects of the present disclosure, a device comprises at least one separator, at least a portion of which can undergo a phase change under conditions occurring in the device; a pyrotechnic composition, proximate to a first surface of the at least one separator; and at least one gas generating composition comprising a metal hydride, proximate to a second surface of the at least one separator, wherein the at least one separator is positioned between the pyrotechnic and gas generating compositions, wherein at least a portion of the at least one separator is configured to undergo a phase change, using heat generated by a reaction of the pyrotechnic composition.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the pyrotechnic composition may be a thermite composition comprising a mixture of a metal fuel and a metal oxide oxidizer that undergoes an exothermic reduction-oxidation reaction when ignited by heat.

In embodiments, the at least one separator may be configured such that at least a portion of the pyrotechnic composition or its reaction products and at least a portion of the gas generating composition are in direct physical contact following the phase change.

In embodiments, the device may further comprise an igniter configured to ignite the pyrotechnic composition.

In aspects of the present disclosure, a process comprises initiating reaction of a pyrotechnic composition consisting essentially of a metal oxide and a metal to release thermal energy; causing at least a portion of at least one separator to undergo a phase change, using thermal energy released by the reaction; and decomposing, using the thermal energy released by the reaction, at least some of one or more metal hydrides to release hydrogen gas.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the at least one separator may be configured such that at least a portion of the pyrotechnic composition or its reaction products and at least a portion of the one or more metal hydrides are in direct physical contact following the phase change.

In aspects of the present disclosure, an inflatable device comprises an inflatable article; and a self-contained hydrogen generator a) interconnected to the inflatable article; b) configured to inflate the inflatable article; and c) having at least one thermal separator positioned between and in thermal contact with i) a thermite composition comprising a metal oxide and a metal; and ii) at least one gas generating composition comprising a metal hydride, wherein at least a portion of the at least one thermal separator is configured to undergo a phase change, using heat generated by a reaction of the thermite composition.

In embodiments, the at least one thermal separator may comprise a metal.

In embodiments, the at least one thermal separator may comprise at least first and second layers, and a material of the first layer may be different from a material of the second layer.

In embodiments, the at least one thermal separator may comprise a mixture of at least two different materials.

In embodiments, the at least one separator may be configured such that at least a portion of the thermite composition or its reaction products and at least a portion of the gas generating composition are in direct physical contact following the phase change.

In embodiments, the inflatable device may further comprise an igniter configured to ignite the thermite.

In aspects of the present disclosure, a gas generator device comprises a heat-generating composition; a gas generating composition comprising a polymer; and at least one separator, wherein the heat-generating composition is proximate to a first surface of the at least one separator and the gas-generating composition is proximate to a second surface of the at least one separator, and wherein at least a portion of the at least one separator is configured to undergo a phase change, using heat generated by a reaction of the heat-generating composition.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the polymer may be selected from the group consisting of polyethylene, polypropylene, polystyrene, trioxane, polyoxymethylene, and combinations and mixtures thereof.

In embodiments, the heat-generating composition may be a thermite composition comprising a mixture of a metal fuel and a metal oxide oxidizer that undergoes an exothermic reduction-oxidation reaction when ignited by heat.

In embodiments, the at least one separator may be configured such that at least a portion of the heat-generating composition or its reaction products and at least a portion of the gas-generating composition are in direct physical contact following the phase change.

In embodiments, the gas generator device may further comprise an igniter configured to ignite the heat-generating composition.

In aspects of the present disclosure, a method for generating at least one product gas comprises initiating reaction of a heat-generating composition to release thermal energy; using a portion of the thermal energy to cause a phase change in at least a portion of at least one separator positioned between the heat-generating composition and a polymer; and decomposing, with thermal energy released by the reaction and transferred to the polymer, at least some of the polymer to release the at least one product gas.

In embodiments, the at least one separator may comprise a metal.

In embodiments, the at least one separator may comprise at least first and second layers, and a material of the first layer may be different from a material of the second layer.

In embodiments, the at least one separator may comprise a mixture of at least two different materials.

In embodiments, the polymer may be selected from the group consisting of polyethylene, polypropylene, polystyrene, trioxane, polyoxymethylene, and combinations and mixtures thereof.

In embodiments, the heat-generating composition may be a thermite composition comprising a mixture of a metal fuel and a metal oxide oxidizer that undergoes an exothermic reduction-oxidation reaction when ignited by heat.

In embodiments, the at least one separator may be configured such that at least a portion of the heat-generating composition or its reaction products and at least a portion of the polymer are in direct physical contact following the phase change.

The devices and methods of the present disclosure can have several advantages. One possible advantage of the devices and methods of the present disclosure is that they can generate large quantities of thermal energy, and therefore large quantities of the desired gas or mixture of gases, per unit mass of gas generator. Thus, the devices provided herein can be substantially more compact than conventional devices for generating gases and may therefore allow for the provision of one or more product gases in applications where the significant volume of conventional gas storage solutions (e.g. pressurized cylinders) cannot be accommodated. Additionally, because the heat-generating composition undergoes a reaction that preferably produces little or no offgas—or, in other words, because most of the heat generated by the heat-generating composition is retained in the solid or liquid reaction products—a greater fraction of the thermal energy produced is available to decompose the polymer and/or metal hydride.

Another possible advantage of the devices and methods of the present disclosure is that they avoid the safety hazards posed by some conventional devices and methods for providing a desired gas. Particularly, pressurized vessels, e.g. gas cylinders, pose various dangers, particularly in challenging environments such as airborne and space environments. In the practice of the present disclosure, none of the reactants (i.e. the heat-generating composition), the gas starting material (i.e. the polymer and/or metal hydride), or the decomposition product (i.e. the product gas) need ever be pressurized, avoiding the dangers posed by pressurized vessels.

Another possible advantage of the devices and methods of the present disclosure is that the starting materials are resistant to phase change and other unwanted physical and chemical changes prior to reaction of the heat-generating composition. By way of non-limiting example, liquid or gas starting materials may be susceptible to undesirable or even dangerous condensation or freezing when employed in low-temperature environments, e.g. the upper atmosphere and space. By remaining in the solid state and generally nonreactive until ignited, the starting materials used in embodiments of the present disclosure avoid this concern and eliminate the need for costly and/or mass- or volume-intensive liquid or gas storage and handling equipment; in terms of simplicity, long-term storage stability, and cost, storage of solid-state materials is generally far more feasible for many applications than dewars or similar devices for storing liquefied gases.

Another possible advantage of the devices and methods of the present disclosure is that the heat-generating composition may be ignited, and thus the decomposition of the polymer and/or metal hydride into the gas(es) of interest, may be ignited by any of several simple and easy methods. Such methods include, but are not limited to, heat, spark, flame, friction, and other pyrotechnic initiation mechanisms.

Another possible advantage of the devices and methods of the present disclosure is that the chemical makeup of the heat-generating composition may be selected or tuned to provide for a desired reaction rate, reaction temperature, amount of thermal energy produced, etc. Particularly, the temperatures at which various widely available polymers decompose are often well-known; as such, the heat-generating composition may be selected (e.g. a particular metal and a metal oxide may be selected as part of a thermite composition for use as a heat-generating composition) to provide an amount of thermal energy sufficient to heat a selected polymer at least to its decomposition temperature. In some embodiments, decomposition of the polymer(s) and/or metal hydride(s) may produce two or more product gases in a proportion that is at least partially temperature-dependent, and/or it may be desirable to further heat the product gases to trigger a secondary decomposition reaction; by way of non-limiting example, it may be desirable, in some applications, to cause at least some of an ethylene product gas (resulting, e.g., from the thermal decomposition of polyethylene) to be secondarily decomposed to hydrogen gas. As an additional non-limiting example, a higher reaction temperature of the heat-generating composition will in turn increase the amount of thermal energy available to decompose the polymer and/or metal hydride, which in embodiments may cause the polymer and/or metal hydride to decompose more rapidly and thus limit the formation of undesirable byproducts, impurities, or offgases. In this way, by selecting an appropriate chemical makeup of the heat-generating composition, it is possible for those skilled in the art to control or tune the amount, composition, formation rate, etc. of the product gas(es).

Another possible advantage of the devices and methods of the present disclosure is that they can produce product gases without the use of a catalyst. Specifically, the very high temperatures generated by the heat-generating compositions, e.g. thermite compositions, of the present disclosure can facilitate “brute force” thermal decomposition without the need for a catalyst, and the paths by which the polymer and/or metal hydride decomposes at such temperatures can thermodynamically favor the end product gas(es) rather than any intermediate byproducts or impurities. Of course, it may in some embodiments be desirable to include a catalyst and/or to generate a mixture of two or more product gases; such embodiments are expressly contemplated and within the scope of the present disclosure.

These and other advantages will be apparent from the disclosure of the aspects, embodiments, and configurations contained herein.

As used herein, “at least one,” “one or more,” and “and/or” are open-ended expressions that are both conjunctive and disjunctive in operation. For example, each of the expressions “at least one of A, B, and C,” “at least one of A, B, or C,” one or more of A, B, and C,” “one or more of A, B, or C,” and “A, B, and/or C” means A alone, B alone, C alone, A and B together, A and C together, B and C together, or A, B, and C together.

It is to be noted that the term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Polyethylene is a polymer comprising nonpolar, saturated, high molecular weight hydrocarbons. Polyethylenes are divided mainly into two types: (1) low density polyethylene, and (2) high density polyethylene. Polyethylene can also be classified as ultra-high-molecular-weight polyethylene (UHMWPE), ultra-low-molecular-weight polyethylene (ULMWPE), high-molecular-weight polyethylene (HMWPE), high-density cross-linked polyethylene (HDXLPE), cross-linked polyethylene (PEX or XLPE), medium-density polyethylene (MDPE), linear low-density polyethylene (LLDPE), and very-low-density polyethylene (VLDPE).

As used herein, unless otherwise specified, the term “compartment” refers to an area, a layer, a region, or a volume of a gas generator device adjacent to one face, side, or surface of a separator of the gas generator device. A “compartment” of a gas generator device, as that term is used herein, generally has, or is adapted to have, disposed therein a gas-generating composition (e.g. a metal hydride or polymer) or a heat-generating composition (e.g. a thermite mixture). In some embodiments, the gas-generating composition or heat-generating composition may occupy less than the entirety of a compartment (for example, a headspace or air gap may surround the gas-generating composition or heat-generating composition within the compartment), while in other embodiments the gas-generating composition or heat-generating composition may occupy the entirety, or substantially the entirety, of the compartment (for example, the compartment may be a volume lying between one surface of a separator and a sidewall of the gas generator device, and the gas-generating composition or heat-generating composition may fill, or substantially fill, such volume). It is to be expressly understood that two “compartments” of a gas generator device, as that term is used herein, may, but need not, be completely isolated or sealed from one another; in some embodiments, there may be one or more gaps, passages, spaces, or voids (e.g. about a circumferential edge of the separator) that allow gases or other materials to pass from one compartment, adjacent to a first face, side, or surface of a separator, to another compartment, adjacent to a second face, side, or surface of the separator.

As used herein, unless otherwise specified, the term “thermite” refers to a mixture of a metal fuel and a metal oxide oxidizer. The metal oxide may, but need not, be selected from the group consisting essentially of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both.

When ignited by heat, thermite undergoes an exothermic reduction-oxidation (redox) reaction.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

Every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a device according to some embodiments of the present disclosure;

FIG. 2 depicts a process according to some embodiments of the present disclosure;

FIG. 3 depicts another device for generating a desired gas or mixture of gases according to some embodiments of the present disclosure;

FIG. 4 depicts yet another device for generating a desired gas or mixture of gases according to some embodiments of the present disclosure;

FIG. 5A illustrates a first compartment of a device for generating a desired gas or mixture of gases according to some embodiments of the present disclosure;

FIG. 5B illustrates a first compartment and a phase-changing separator of a device for generating a desired gas or mixture of gases according to some embodiments of the present disclosure;

FIG. 5C illustrates a first compartment, a phase-changing separator, and a second compartment of a device for generating a desired gas or mixture of gases according to some embodiments of the present disclosure;

FIG. 6 illustrates an inflatable device according to some embodiments of the present disclosure;

FIGS. 7A through 7D illustrate a device for generating a desired gas or mixture of gases, respectively before (FIG. 7A), upon initiation of (FIG. 7B), during an early portion of (FIG. 7C), and after or during a late portion of (FIG. 7D) a thermite reaction according to some embodiments of the present disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Summary prevails unless otherwise stated.

For purposes of further disclosure and to comply with applicable written description and enablement requirements, the following references generally relate to systems and methods for gas generation and are hereby incorporated by reference in their entireties:

U.S. Pat. No. 10,220,930, entitled “Thermal hydrogen generator using a metal hydride and thermite,” issued 5 Mar. 2019 to Bognar (“the '930 patent”).

U.S. Pat. No. 10,532,800, entitled “Thermal hydrogen generator using a metal hydride and thermite,” issued 14 Jan. 2020 to Bognar (“the '800 patent”).

U.S. patent application Ser. No. 16/741,508, entitled “Thermal hydrogen generator using a metal hydride and thermite,” filed 13 Jan. 2020 by Bognar (“the '508 application”).

U.S. patent application Ser. No. 16/944,132, entitled “Thermal gas generator,” filed 30 Jul. 2020 by Bognar (“the '132 application”).

Gas generator devices according to the present disclosure generally utilize a reaction of a heat-generating and/or pyrotechnic composition, often a thermite mixture, to create thermal energy that in turn causes the thermal decomposition of a gas-generating composition, typically a metal hydride and/or a polymer. At least some of the thermal energy created by the reaction of the heat-generating composition is conveyed or transferred to one or more separators. Although devices of this general type are known and described, for example, in the '930 patent, the '800 patent, the '508 application, and the '132 application, the gas generator devices of the present disclosure provide an important advantage and benefit in the form of phase-changing separators, i.e. separators that at least partially melt, vaporize, or sublimate as a result of the heat generated by reaction of the heat-generating composition.

A phase-changing separator according to the present disclosure addresses drawbacks, or otherwise improves the function, of gas generator devices according to the prior art in several ways. As a first non-limiting example, because the separator is in a solid physical state prior to initiation of the reaction in the heat-generating composition but at least a portion thereof becomes a liquid or gas during the reaction, the gas-generating composition can be physically separated from the heat-generating composition during manufacture and storage of the device (e.g. to prevent undesired mixing of the two compositions) but allowed to come into direct contact with the heat-generating composition (or slags or reaction products thereof) during and/or after reaction of the heat-generating composition (e.g. to promote complete decomposition of the gas-generating composition, or to accelerate the rate of the reaction). As a second non-limiting example, the phase-changing separator can allow the reaction of the heat-generating composition to proceed substantially to completion before any significant decomposition of the gas-generating composition occurs; in this way, gases evolved from the decomposition of the gas-generating composition will not react with metal oxides in the heat-generating composition or compete with the heat-generating composition for reaction with oxygen, thereby preventing quenching of the heat-generating composition and premature termination of the reactions within the device. As a third non-limiting example, the phase-changing separator can, in some embodiments, undergo an incomplete or partial phase change, i.e. wherein a portion of the separator undergoes a phase change while another portion of the separator remains in the solid state; in this way, it may be possible to achieve one or more other advantages of a phase-changing separator as described herein, while simultaneously achieving one or more advantages of a non-phase-changing separator (e.g. maintaining reaction products/slags of the heat-generating composition and/or the gas-generating composition in a desired compartment or physical orientation, preventing reaction products/slags of the heat-generating composition from coming in contact with the gas-generating composition or reaction products/slags thereof (or vice versa), providing a selected extent of “burn-through” of the heat-generating composition, etc.).

In some embodiments, the phase-changing separator(s) may be at least partially constructed of a metal alloy having a melting, vaporization, and/or sublimation temperature lower than the temperature achieved by the reaction of the heat-generating composition. Non-limiting examples of such metals include iron, aluminum, copper, tin, zinc, and alloys and mixtures of those and other metals. In some embodiments, the phase-changing separator(s) may be constructed principally or entirely of such alloys, while in other embodiments the phase-changing separator(s) may include a significant fraction or portion of one or more materials that have a melting, vaporization, and/or sublimation temperature higher than the temperature achieved by the reaction of the heat-generating composition, to provide phase-changing separator(s) configured to undergo an incomplete or partial phase change.

In some embodiments, the phase-changing separator(s) may be constructed of multiple layers of two or more different materials. This construction may be particularly advantageous where it is desirable to provide a separator that melts, vaporizes, and/or sublimates in a gradual or staged fashion, i.e. where a first layer or portion of the separator melts, vaporizes, and/or sublimates at a first temperature and a second layer or portion of the separator melts, vaporizes, and/or sublimates at a second, higher temperature during reaction of the heat-generating composition. This construction may also be particularly advantageous where it is desirable to provide a separator that undergoes an incomplete or partial phase change, i.e. where a first layer or portion of the separator melts, vaporizes, and/or sublimates and a second layer or portion of the separator does not melt, vaporize, and/or sublimate.

In some embodiments, the separator(s) may be constructed principally of a combination or mixture of at least two different materials, such as a metal alloy. Non-limiting examples of such combinations and mixtures include steel and brass. The combination or mixture may be substantially homogeneous, or may be provided in a spatially varying form, i.e. where certain regions of the separator are particularly rich (or poor) in a selected component of the combination or mixture.

In some embodiments, the phase change of the phase-changing separator(s) (or portion thereof) during reaction of the heat-generating composition may be melting. Separators of this type may be particularly advantageous in applications in which it is desirable for the separator to remain in a liquid form after reaction. Non-limiting examples of material suitable for construction of melting separators include silicon dioxide and glasses.

In some embodiments, the phase change of the phase-changing separator(s) (or portion thereof) during reaction of the heat-generating composition may be sublimation. Separators of this type may be particularly advantageous in applications in which it is desirable for the separator to be provided in a solid form prior to reaction and/or where the separator material itself is a product gas intended to be produced by the gas generator device.

In some embodiments, particularly where the desired product gas is or comprises hydrogen gas, the gas-generating composition may comprise one or more metal hydrides. Non-limiting examples of metal hydrides suitable for use in gas generator devices as disclosed herein include lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and mixtures thereof.

In some embodiments, particularly where the desired product gas is or comprises a hydrocarbon such as ethylene, the gas-generating composition may comprise one or more polymers. Non-limiting examples of polymers suitable for use in gas generator devices as disclosed herein include polyethylene, polypropylene, polystyrene, trioxane, and polyoxymethylene.

The heat-generating composition can be a thermite composition, i.e. a mixture of a metal oxide and a metal. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both.

In some configurations, the phase-changing separator can be provided as a shaped or molded article comprising voids, wherein at least a portion of the voids are occupied by one or both of 1) a thermite mixture or other heat-generating mixture (such mixture is preferably not gas generating on its own), and 2) a gas-generating composition, such as any one or more thermally decomposable polymers and/or metal hydrides, which may be in forms such as but not limited to pellets, sheets, tubes, rods, fibers, or custom molded shapes. The heat-generating composition and the gas-generating composition can come into thermal contact with each other by virtue of the melting, vaporization, or sublimation of portions of the shaped or molded article proximate to one or more voids occupied by either or both of the heat-generating composition and the gas-generating composition, thus causing the voids to collapse.

To start the generator, the heat-generating material, e.g., thermite mixture (such as but not limited to a mixture of aluminum metal and iron (III) oxide), can be ignited to produce heat. As heat or thermal energy is conducted from the heat-generating composition to the polymer and/or metal hydride, a mixture of gases (e.g. including, in the case of polyethylene, a substantial portion of ethylene) is initially produced as the polymer and/or metal hydride decomposes. This gas mixture may be used as-is, thermally and/or catalytically treated to yield a more desirable gas mixture, and/or have undesirable components removed through means such as but not limited to filters, sieves, traps, or condensers.

Various embodiments of the gas generator device will now be discussed with reference to the figures.

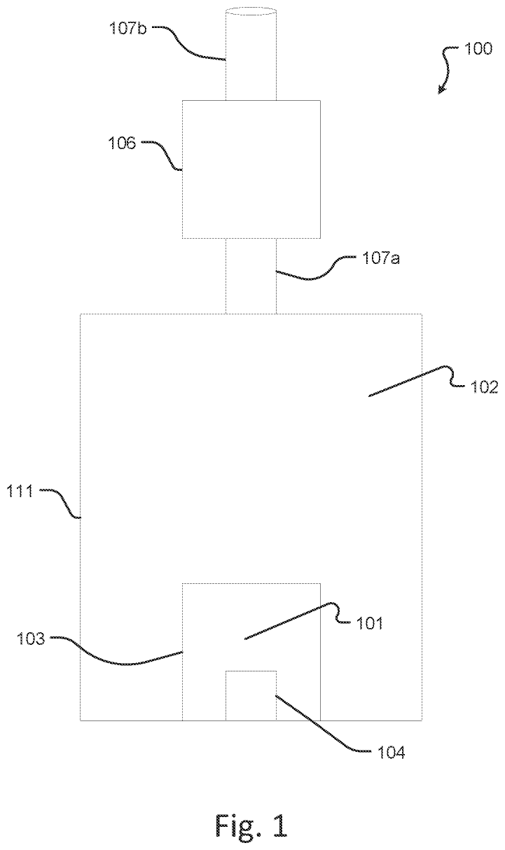

FIG. 1 depicts a non-limiting configuration of a gas generator device 100. The gas generator device 100 comprises a first compartment 101 containing a heat-generating composition and a second compartment 102 containing a polymer and/or metal hydride (a “gas-generating composition”). The first 101 and second 102 compartments are typically separated from an outside environment by a wall 111 and from each other by a phase-changing separator 103; in some embodiments, there may be more than one first compartment 101 and/or more than one second compartment 102. It is to be expressly understood that the first 101 and second 102 compartments, may, but need not, be completely isolated or sealed from one another; in some embodiments, there may be one or more gaps, passages, spaces, or voids (e.g. about a circumferential edge of the phase-changing separator 103) that allow gases or other materials to pass from the first compartment 101, adjacent to a first face, side, or surface of the phase-changing separator 103, to the second compartment 102, adjacent to a second face, side, or surface of the phase-changing separator 103. The phase-changing separator 103 is in thermal contact with the first 101 and second 102 compartments. Thermal energy generated in the first compartment 101 by reaction of the heat-generating composition is transferred to the second compartment 102 by the phase-changing separator 103, whereby at least some of the thermal energy transferred to the second compartment 102 thermally decomposes at least some of the polymer and/or metal hydride to release at least one product gas.

The first 101 and second 102 compartments have first and second compartment volumes, respectively. The gas generator device 100 has a device volume. In some configurations the device volume can be the sum of the first 101 and second 102 compartment volumes. In some configurations, the device volume can be more than the sum of the first 101 and second 102 compartment volumes. In some configurations, the first 101 and second 102 compartments can be stacked one atop the other; it will be appreciated that the compartments can be stacked in any order. In other configurations, the first 101 and second 102 compartments can be arranged with one of the compartments partly or completely encased in the other, as for example depicted without limitation in FIG. 1. The walls 111 that separate one or both of first 101 and second 102 compartments from a surrounding environment may comprise, separately and independently, one or more of steel, aluminum, and ceramic.

In some embodiments, the first compartment 101 is configured with one or more vents (not depicted).

Most typically, the heat-generating composition comprises a thermite composition, which in turn comprises a metal (i.e. a fuel) and a metal oxide (i.e. an oxidizer). The thermite reaction, i.e. the exothermic reduction-oxidation reaction between a metal fuel and a metal oxide when ignited by heat, has been known for well over a century; see, e.g., U.S. Patent 906,009, entitled “Manufacture of thermic mixtures,” issued 8 Dec. 1908 to Goldschmidt (“Goldschmidt”), the entirety of which is incorporated herein by reference. The thermite reaction is generally non-explosive but can create intense heat and high temperatures; it thus finds a variety of useful applications, (e.g. welding, metal refining, disabling munitions, incendiary weapons, and pyrotechnic initiators) and so is widely, and (for many formulations) inexpensively, available from many suppliers. The metal oxide may, but need not, be selected from the group consisting essentially of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both.

In one configuration, the heat-generating composition comprises a thermite composition that comprises a mixture of ferric oxide and aluminum. The chemical reaction of this thermite mixture is shown below in chemical equation (1):

Fe₂O₃(s)+2Al(s)→2Fe(s)+Al₂O₃(s) (1)

The thermite chemical reaction is exothermic and releases a large quantity of thermal energy, resulting in temperatures sufficient to produce an aluminum oxide slag and molten iron. The enthalpy or heat of reaction (ΔH° value) for the thermite reaction is about −849 kJ (e.g., −849 kJ per mole Fe₂O₃). The thermite reaction does not require external oxygen and can, therefore, proceed in locations with limited or no air flow (e.g. in space), or even under water. Furthermore, the reaction of many types and mixtures of thermite does not produce any gases which might carry away some of the heat of the reaction or produce an explosive excess of pressure.

It can be appreciated that the heat-generating composition can generate very large amounts of thermal energy per unit mass of the heat-generating composition. A compact gas generating system can thus be achieved by producing such large amounts of thermal energy per unit mass of the heat-generating composition. Furthermore, in many embodiments, substantially most of the heat generated remains available to decompose the polymer and/or metal hydride because gaseous byproducts are not produced; that is, most of the heat is retained in the liquid and/or solid reaction products as a source of thermal energy.

Typically, at least some of the thermal energy transferred to the second compartment 102 by the phase-changing separator 103 thermally decomposes some of the polymer and/or metal hydride contained in the second compartment 102. The thermal decomposition of the polymer and/or metal hydride releases one or more product gases. By way of non-limiting example, polyethylene can be thermally decomposed to ethylene gas, and in some embodiments at least a portion of the ethylene gas may be secondarily decomposed (either thermally or catalytically) to hydrogen gas.

In some embodiments, at least about 99 mole % of the polymer and/or metal hydride may be converted to the one or more product gases. More generally, at least 95 mole %, even more generally at least about 90 mole %, yet even more generally at least about 80 mole %, still yet even more generally at least about 70 mole %, still yet even more generally at least about 60 mole %, still yet even more generally at least about 50 mole %, still yet even more generally at least about 40 mole %, still yet even more generally at least about 30 mole %, still yet even more generally at least about 20 mole %, or yet still even more generally at least about 10 mole % of the polymer and/or metal hydride may be converted to the one or more product gases.

It can be appreciated that, in many embodiments, there is no need to control one or both of the temperature or thermal energy transfer within the device 100. As a result, the device 100 can be configured to transfer thermal energy rapidly between the first 101 and second 102 compartments, thereby decomposing the polymer and/or metal hydride to release the one or more product gases more rapidly than current gas generation systems. Moreover, the device 100 can be more easily constructed and operated than other gas generators; for example, there is not always a need to have the polymer and/or metal hydride decomposition occur at any specific temperature, so neither the reaction of the heat-generating composition nor the transfer of thermal energy from the first 101 to the second 102 compartment must necessarily be regulated. This contrasts with catalytic decomposition methods, which require the catalyst to be operated at specific temperatures, pressures, and reactant flow rates. Even more advantageously, in those embodiments where control over one or both of the temperature or the rate of energy transfer within the device 100 is required or desired, such control can be achieved by varying the chemical makeup of the thermite or other heat-generating composition within the first compartment 101, without the need to rebuild or retrofit the device 100 itself.

The gas generator device 100 may further include an igniter 104 interconnected with the first compartment. The igniter 104 causes the ignition of the heat-generating composition. In some configurations, a spark generated within the igniter 104 initiates the ignition process. In other configurations, the ignition process is initiated by thermal energy generated within the igniter 104. The thermal energy provided within igniter 104 may be from a hot wire. In other configurations, the initiating energy within igniter 104 may be from flame. In other configurations, the initiating energy within the igniter 104 may be provided by friction.

The igniter 104 may further comprise an ignition aperture in the first compartment 101. The ignition aperture may be configured with a safety-delay switch system.

The gas generator device 100 may further include a heat exchanger 106 interconnected with the second compartment 102. The heat exchanger 106 is configured to cool the product gas(es) released from the polymer and/or metal hydride. In accordance with some embodiments, the heat exchanger 106 may be interconnected to outlet 107a of the second compartment 102. The exchanger 106 cools the product gas(es) exiting the second compartment 102 through outlet 107a and releases the cooled gas through outlet 107b.

It is to be expressly understood that that the first 101 and second 102 compartments can be spatially arranged in any suitable configuration. By way of non-limiting example, in some embodiments, the compartments can be stacked atop each other, while in other embodiments one of the compartments can be partially or completely encased within or surrounded by the other compartment, the compartments may lie in a horizontal plane (e.g. the first compartment 101 may be a “left” compartment and the second compartment 102 may be a “right” compartment, or vice versa), or the compartments may have a more complex geometric relationship (e.g. the phase-changing separator 103 may be spiral-shaped, with the first compartment 101 lying adjacent to an outer surface of the spiral-shaped separator 103 and the second compartment 102 lying adjacent to an inner surface of the spiral-shaped separator 103, or vice versa).

At least some of the thermal energy created by the reaction of the heat-generating composition is conveyed or transferred to the phase-changing separator 103. The phase-changing separator 103 at least partially melts, vaporizes, or sublimates as a result of the heat generated by reaction of the heat-generating composition.

Because the phase-changing separator 103 is in a solid physical state prior to initiation of the reaction in the heat-generating composition but at least a portion thereof becomes a liquid or gas during the reaction, the gas-generating composition can, in some embodiments, be physically separated from the heat-generating composition during manufacture and storage of the device 100 (e.g. to prevent undesired mixing of the two compositions) but allowed to come into direct contact with the heat-generating composition (or slags or reaction products thereof) during and/or after reaction of the heat-generating composition (e.g. to promote complete decomposition of the gas-generating composition, or to accelerate the rate of the reaction). In some embodiments, the phase-changing separator 103 may allow the reaction of the heat-generating composition to proceed substantially to completion before any significant decomposition of the gas-generating composition occurs; in this way, gases evolved from the decomposition of the gas-generating composition will not react with metal oxides in the heat-generating composition or compete with the heat-generating composition for reaction with oxygen, thereby preventing quenching of the heat-generating composition and premature termination of the reactions within the device 100. The phase-changing separator 103 can, in some embodiments, undergo an incomplete or partial phase change, i.e. wherein a portion of the phase-changing separator 103 undergoes a phase change while another portion of the phase-changing separator 103 remains in the solid state; in this way, it may be possible to achieve one or more of the advantages of a phase-changing separator 103, while simultaneously achieving one or more advantages of a non-phase-changing separator (e.g. maintaining reaction products/slags of the heat-generating composition and/or the gas-generating composition in a desired compartment or physical orientation, preventing reaction products/slags of the heat-generating composition from coming in contact with the gas-generating composition or reaction products/slags thereof (or vice versa), providing a selected extent of “burn-through” of the heat-generating composition, etc.).

In some embodiments, the phase-changing separator 103 may be at least partially constructed of a metal alloy having a melting, vaporization, and/or sublimation temperature lower than the temperature achieved by the reaction of the heat-generating composition. Non-limiting examples of such metals include iron, aluminum, copper, tin, zinc, and alloys and mixtures of those and other metals. In some embodiments, the phase-changing separator 103 may be constructed principally or entirely of such alloys, while in other embodiments the phase-changing separator 103 may include a significant fraction or portion of one or more materials that have a melting, vaporization, and/or sublimation temperature higher than the temperature achieved by the reaction of the heat-generating composition, to provide a phase-changing separator 103 configured to undergo an incomplete or partial phase change.

In some embodiments, the phase-changing separator 103 may be constructed of multiple layers of two or more different materials. This construction may be particularly advantageous where it is desirable to provide a phase-changing separator 103 that melts, vaporizes, and/or sublimates in a gradual or staged fashion, i.e. where a first layer or portion of the phase-changing separator 103 melts, vaporizes, and/or sublimates at a first temperature and a second layer or portion of the phase-changing separator 103 melts, vaporizes, and/or sublimates at a second, higher temperature during reaction of the heat-generating composition. This construction may also be particularly advantageous where it is desirable to provide a phase-changing separator 103 that undergoes an incomplete or partial phase change, i.e. where a first layer or portion of the phase-changing separator 103 melts, vaporizes, and/or sublimates and a second layer or portion of the phase-changing separator 103 does not melt, vaporize, and/or sublimate.

In some embodiments, the phase-changing separator 103 may be constructed principally of a combination or mixture of at least two different materials, such as a metal alloy. Non-limiting examples of such combinations and mixtures include steel and brass. The combination or mixture may be substantially homogeneous, or may be provided in a spatially varying form, i.e. where certain regions of the phase-changing separator 103 are particularly rich (or poor) in a selected component of the combination or mixture.

In some embodiments, the phase change of the phase-changing separator 103 (or portion thereof) during reaction of the heat-generating composition may be melting. Phase-changing separators 103 of this type may be particularly advantageous in applications in which it is desirable for the phase-changing separator 103 to remain in a liquid form after reaction. Non-limiting examples of material suitable for construction of melting separators include silicon dioxide and glasses.

In some embodiments, the phase change of the phase-changing separator 103 (or portion thereof) during reaction of the heat-generating composition may be sublimation. Separators of this type may be particularly advantageous in applications in which it is desirable for the phase-changing separator 103 to be provided in a solid form prior to reaction and/or where the material of the phase-changing separator 103 itself is a product gas intended to be produced by the gas generator device 100.

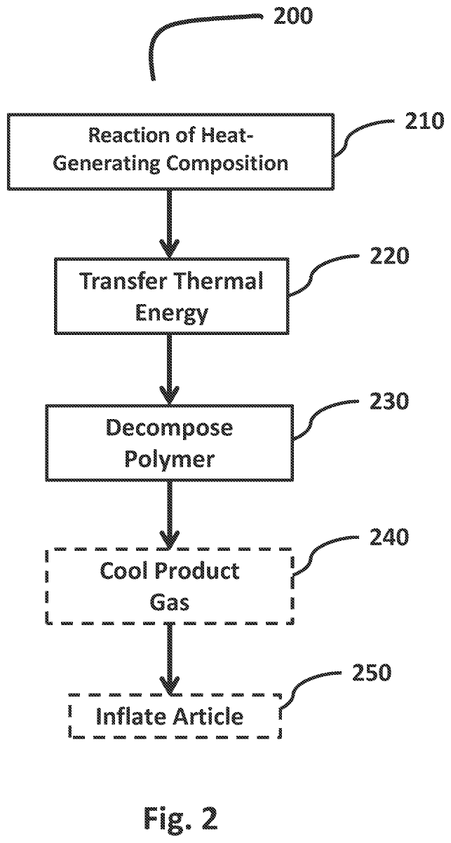

FIG. 2 depicts a process 200 for using the gas generator device 100 of FIG. 1.

In step 210, reaction of a heat-generating composition is initiated in a first compartment 101. The reaction releases thermal energy. The heat-generating composition may be a thermite composition comprised of a metal and a metal oxide. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both.

Step 210 may further include contacting the heat-generating composition with an igniter to initiate the reaction. In some configurations the reaction may be initiated by contacting the igniter with one of a hot wire or a spark. In other configurations, flame may initiate the reaction of the heat-generating composition via the igniter. In yet other configurations, friction may initiate reaction of the heat-generating composition via the igniter.

In step 220, the energy released by the reaction of the heat-generating composition is transferred from the first compartment 101 to a second compartment 102. A polymer and/or metal hydride is contained in the second compartment. Non-limiting examples of polymer suitable for use include various forms of polyethylene (e.g. low-density polyethylene (LDPE), high-density polyethylene (HDPE), and mixtures thereof), polypropylene, polystyrene, trioxane, polyoxymethylene, and combinations, copolymers, and mixtures thereof. Non-limiting examples of metal hydride suitable for use include lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and combinations and mixtures thereof.

In step 230, the thermal energy transferred to the second compartment 102 decomposes the polymer and/or metal hydride to release one or more product gases. Step 230 includes transferring the released thermal energy from the first compartment 101 to the second compartment 102 through a phase-changing separator 103. The material and construction of the phase-changing separator 103, and the composition and amount of the polymer and/or metal hydride in the second compartment 102, can be selected to provide for a desired amount or rate of production of the product gas(es). By way of non-limiting example, the phase-changing separator 103 can be constructed such that the gas-generating composition is physically separated from the heat-generating composition during manufacture and storage of the device 100 (e.g. to prevent undesired mixing of the two compositions) but, as a result of at least a portion of the phase-changing separator 103 becoming a liquid or gas during reaction of the heat-generating composition, the gas-generating composition may be allowed to come into direct contact with the heat-generating composition (or slags or reaction products thereof) during and/or after reaction of the heat-generating composition (e.g. to promote complete decomposition of the gas-generating composition, or to accelerate the rate of the reaction).

In optional step 240, the released product gas(es) may be cooled, in some embodiments by a heat exchanger.

In optional step 250, the released gas may be used for one of: inflation of a meteorological balloon; inflation of other types of balloons; inflation of a blimp; inflation of a hypersonic inflatable aerodynamic decelerator (HIAD); inflation of an inflatable article; pressurization of a gas storage cylinder; and the like.

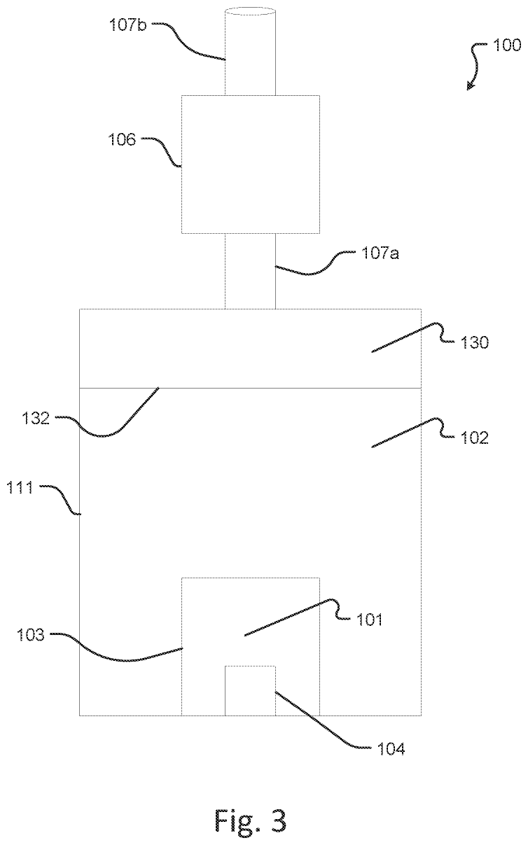

FIG. 3 depicts a device for generating at least one product gas according to various embodiments as described in the above Summary and Detailed Description and hereinbelow. More specifically, FIG. 3 depicts a device 100 having first 101, second 102, and third 130 compartments, with the second compartment 102 positioned between the first compartment 101 and the third compartment 130. The first 101, second 102, and third 130 compartments have walls 111. A phase-changing separator 103 separates the first 101 and second 102 compartments. The phase-changing separator 103 is in thermal contact with the first 101 and second 102 compartments. A partition 132 separates the second 102 and third 130 compartments. The first compartment 101 contains a heat-generating composition (not depicted); the second compartment 102 contains a polymer and/or metal hydride (not depicted); and the third compartment 130 contains a catalyst which can reform the gas exiting compartment 102.

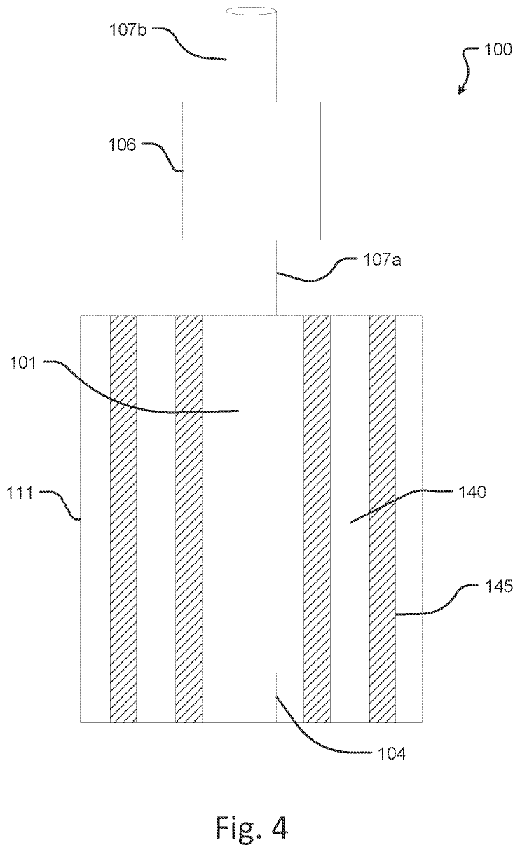

FIG. 4 depicts a non-limiting configuration of a gas generator device 100. The gas generator device 100 comprises a single or common compartment 101 containing both the heat-generating composition and the polymer and/or metal hydride in discrete form such as rods 140, in contrast to the device 100 depicted in FIG. 1. The compartment 101 is typically separated from an outside environment by a wall 111. Thermal energy generated by reaction of the heat-generating composition can be received by the polymer and/or metal hydride, whereby at least some of the thermal energy thermally decomposes at least some of the polymer and/or metal hydride to release at least one product gas. Transfer of the energy generated by the heat-generating composition to the polymer and/or metal hydride is moderated by a phase-changing separator layer 145. As will be appreciated, the phase-changing separator layer 145 which moderates heat transfer between the heat-generating composition and the polymer and/or metal hydride can be a continuous or discontinuous layer on the polymer and/or metal hydride, the heat-generating composition, or both depending on the configuration.

Typically, at least some of the thermal energy available to the polymer and/or metal hydride due to the reaction of the heat-generating composition in the compartment 101 thermally decomposes some of the polymer and/or metal hydride contained in the compartment 101. The thermal decomposition of the polymer and/or metal hydride releases one or more product gases. By way of non-limiting example, polyethylene can be thermally decomposed to ethylene gas, and in some embodiments at least a portion of the ethylene gas may be secondarily decomposed (either thermally or catalytically) to hydrogen gas.

In some embodiments, at least about 99 mole % of the polymer and/or metal hydride may be converted to the one or more product gases. More generally, at least 95 mole %, even more generally at least about 90 mole %, yet even more generally at least about 80 mole %, still yet even more generally at least about 70 mole %, still yet even more generally at least about 60 mole %, still yet even more generally at least about 50 mole %, still yet even more generally at least about 40 mole %, still yet even more generally at least about 30 mole %, still yet even more generally at least about 20 mole %, or yet still even more generally at least about 10 mole % of the polymer and/or metal hydride may be converted to the one or more product gases.

It can be appreciated that, in many embodiments, there is no need to control one or both of the temperature or thermal energy transfer within the device 100. Moreover, the device 100 can be more easily constructed and operated than other gas generators; for example, the absence of a second compartment may simplify the design of the device 100 and be suitable for applications in which transfer of substantially all of the thermal energy generated by reaction of the heat-generating composition to the polymer and/or metal hydride is desirable. Even more advantageously, in those embodiments where control over one or both of the temperature or the rate of energy transfer within the device 100 is required or desired, such control can be achieved by varying the chemical makeup of the thermite or other heat-generating composition within the compartment 101, and/or the spatial arrangement of the polymer and/or metal hydride relative to the heat-generating composition in the compartment 101, without the need to redesign the device 100 itself.

The gas generator device 100 may further include an igniter 104 interconnected with the compartment 101. The igniter 104 causes the ignition of the heat-generating composition. In some configurations, a spark generated within the igniter 104 initiates the ignition process. In other configurations, the ignition process is initiated by thermal energy generated within the igniter 104. The thermal energy provided within igniter 104 may be from a hot wire. In other configurations, the initiating energy within igniter 104 may be from flame. In other configurations, the initiating energy within the igniter 104 may be provided by friction.

The igniter 104 may further comprise an ignition aperture in the compartment 101. The ignition aperture may be configured with a safety-delay switch system.

The gas generator device 100 may further include a heat exchanger 106 interconnected with the compartment 101. The heat exchanger 106 is configured to cool the product gas(es) released from the polymer and/or metal hydride. In accordance with some embodiments, the heat exchanger 106 may be interconnected to outlet 107a of the compartment 101. The exchanger 106 cools the product gas(es) exiting the compartment 101 through outlet 107a, with the cooled gas exiting the exchanger 106 via outlet 107b.

At least some of the thermal energy created by the reaction of the heat-generating composition is conveyed or transferred to the phase-changing separator layer 145. The phase-changing separator layer 145 at least partially melts, vaporizes, or sublimates as a result of the heat generated by reaction of the heat-generating composition.

Because the phase-changing separator layer 145 is in a solid physical state prior to initiation of the reaction in the heat-generating composition but at least a portion thereof becomes a liquid or gas during the reaction, the gas-generating composition can, in some embodiments, be physically separated from the heat-generating composition during manufacture and storage of the device 100 (e.g. to prevent undesired mixing of the two compositions) but allowed to come into direct contact with the heat-generating composition (or slags or reaction products thereof) during and/or after reaction of the heat-generating composition (e.g. to promote complete decomposition of the gas-generating composition, or to accelerate the rate of the reaction). In some embodiments, the phase-changing separator layer 145 may allow the reaction of the heat-generating composition to proceed substantially to completion before any significant decomposition of the gas-generating composition occurs; in this way, gases evolved from the decomposition of the gas-generating composition will not react with metal oxides in the heat-generating composition or compete with the heat-generating composition for reaction with oxygen, thereby preventing quenching of the heat-generating composition and premature termination of the reactions within the device 100. The phase-changing separator layer 145 can, in some embodiments, undergo an incomplete or partial phase change, i.e. wherein a portion of the phase-changing separator layer 145 undergoes a phase change while another portion of the phase-changing separator layer 145 remains in the solid state; in this way, it may be possible to achieve one or more of the advantages of a phase-changing separator 103, while simultaneously achieving one or more advantages of a non-phase-changing separator layer (e.g. preventing reaction products/slags of the heat-generating composition from coming in contact with the gas-generating composition or reaction products/slags thereof (or vice versa), providing a selected extent of “burn-through” of the heat-generating composition, etc.).

In some embodiments, the phase-changing separator layer 145 may be at least partially constructed of a metal alloy having a melting, vaporization, and/or sublimation temperature lower than the temperature achieved by the reaction of the heat-generating composition. Non-limiting examples of such metals include iron, aluminum, copper, tin, zinc, and alloys and mixtures of those and other metals. In some embodiments, the phase-changing separator layer 145 may be constructed principally or entirely of such alloys, while in other embodiments the phase-changing separator layer 145 may include a significant fraction or portion of one or more materials that have a melting, vaporization, and/or sublimation temperature higher than the temperature achieved by the reaction of the heat-generating composition, to provide a phase-changing separator layer 145 configured to undergo an incomplete or partial phase change.

In some embodiments, the phase-changing separator layer 145 may be constructed of multiple sub-layers of two or more different materials. This construction may be particularly advantageous where it is desirable to provide a phase-changing separator layer 145 that melts, vaporizes, and/or sublimates in a gradual or staged fashion, i.e. where a first sub-layer or portion of the phase-changing separator layer 145 melts, vaporizes, and/or sublimates at a first temperature and a second sub-layer or portion of the phase-changing separator layer 145 melts, vaporizes, and/or sublimates at a second, higher temperature during reaction of the heat-generating composition. This construction may also be particularly advantageous where it is desirable to provide a phase-changing separator layer 145 that undergoes an incomplete or partial phase change, i.e. where a first sub-layer or portion of the phase-changing separator layer 145 melts, vaporizes, and/or sublimates and a second sub-layer or portion of the phase-changing separator layer 145 does not melt, vaporize, and/or sublimate.

In some embodiments, the phase-changing separator layer 145 may be constructed principally of a combination or mixture of at least two different materials, such as a metal alloy. Non-limiting examples of such combinations and mixtures include steel and brass. The combination or mixture may be substantially homogeneous, or may be provided in a spatially varying form, i.e. where certain regions of the phase-changing separator layer 145 are particularly rich (or poor) in a selected component of the combination or mixture.

In some embodiments, the phase change of the phase-changing separator layer 145 (or portion thereof) during reaction of the heat-generating composition may be melting. Phase-changing separator layers 145 of this type may be particularly advantageous in applications in which it is desirable for the phase-changing separator layer 145 to remain in a liquid form after reaction. Non-limiting examples of material suitable for construction of melting separators include silicon dioxide and glasses.

In some embodiments, the phase change of the phase-changing separator layer 145 (or portion thereof) during reaction of the heat-generating composition may be sublimation. Separators of this type may be particularly advantageous in applications in which it is desirable for the phase-changing separator layer 145 to be provided in a solid form prior to reaction and/or where the material of the phase-changing separator layer 145 itself is a product gas intended to be produced by the gas generator device 100.

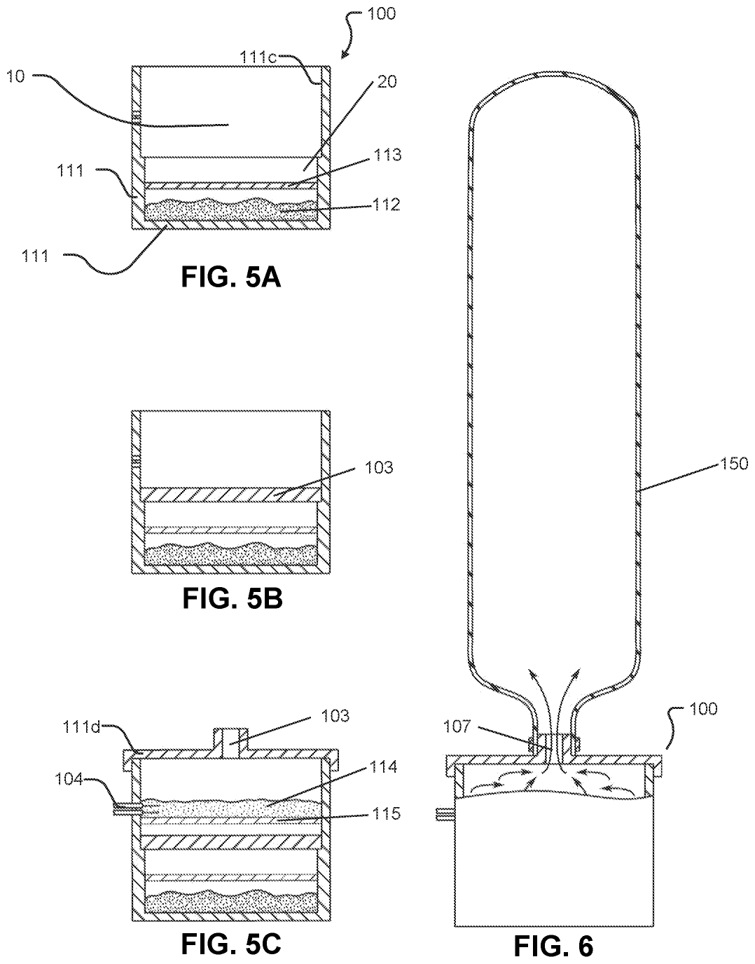

Referring now to FIGS. 5A through 5C, a non-limiting configuration of a gas generator device 100 is illustrated at various stages of construction. The container initially (FIG. 5A) includes an upper chamber 10 and a lower chamber 20, which, after placement of a phase-changing separator 103 (FIGS. 5B, 5C), become upper 101 and lower 102 compartments of the gas generator device 100. The upper 10 and lower 20 chambers are separated from an outside environment by a base wall 111a and side walls 111b,c and, after placement of the phase-changing separator 103, from each other by the phase-changing separator 103. In some embodiments, there may be more than one upper chamber 10/upper compartment 101 and/or more than one lower chamber 20/lower compartment 102. It is to be expressly understood that after placement of the phase-changing separator 103, the upper 101 and lower 102 compartments, may, but need not, be completely isolated or sealed from one another; in some embodiments, there may be one or more gaps, passages, spaces, or voids (e.g. about a circumferential edge of the phase-changing separator 103) that allow gases or other materials to pass from the lower compartment 102, adjacent to a first face, side, or surface of the phase-changing separator 103, to the upper compartment 101, adjacent to a second face, side, or surface of the phase-changing separator 103, or vice versa.

The upper chamber 10/upper compartment 101 and lower chamber 20/lower compartment 102 have first and second volumes, respectively. The gas generator device 100 has a device volume. In some configurations the device volume can be the sum of the upper 101 and lower 102 compartment volumes. In some configurations, the device volume can be more than the sum of the upper 101 and lower 102 compartment volumes. Although the upper 101 and lower 102 compartments are, in the embodiment illustrated in FIGS. 5A through 5C, stacked one atop the other, it will be appreciated that the compartments can be stacked in any order, or, in other configurations, the upper 101 and lower 102 compartments can be arranged with one of the compartments partly or completely encased in the other. Other spatial configurations are also possible; by way of non-limiting example, the compartments may lie in a horizontal plane (e.g. the upper compartment 101 may instead be a “left” compartment and the lower compartment 102 may instead be a “right” compartment, or vice versa), or the compartments may have a more complex geometric relationship (e.g. the phase-changing separator 103 may be spiral-shaped, with the upper compartment 101 lying adjacent to an outer surface of the spiral-shaped separator 103 and the lower compartment 102 lying adjacent to an inner surface of the spiral-shaped separator 103, or vice versa) One or more of walls 111a,b,c may comprise, separately and independently, one or more of steel, aluminum, and ceramic.

In some embodiments, the upper compartment 101 is configured with one or more vents (not depicted).

As illustrated in FIG. 5A, after provision of the container having base wall 111a and side walls 111b,c, construction of the gas generator device 100 proceeds by placing a gas-generating composition 112, such as any one or more thermally decomposable polymers and/or metal hydrides, into the lower chamber 20, which initially may not be physically separated from the upper chamber 10 (the line between the two chambers in FIG. 5A is shown only for the purpose of illustrating the delineation between the upper 10 and lower 20 chambers and does not necessarily represent a physical barrier). The gas-generating composition 112 may be in forms such as but not limited to pellets, sheets, tubes, rods, fibers, or custom molded shapes.

Optionally, a sealing element 113 may then be placed over the gas-generating composition 112 to hold the gas-generating composition 112 in place in the lower chamber 20; the sealing element 113, if provided, may be in direct physical contact with the gas-generating composition 112, or, as illustrated in FIG. 5A, there may be a gap or headspace between the gas-generating composition 112 and the sealing element 113. In some embodiments, the sealing element 113 may be a relatively thin and/or flexible component, and/or may be constructed of material(s) having a relatively low melting, vaporization, and/or sublimation temperature, such that the sealing element 113 melts, vaporizes, sublimates, or otherwise disintegrates during operation of the gas generator device 100; one example of a suitable material for a sealing element 113 of this type is aluminum foil.

As illustrated in FIG. 5B, after placement of the gas-generating composition 112 (or, optionally, the sealing element 113) into the lower compartment 20, construction of the gas generator device 100 proceeds by placing a phase-changing separator 103 into the container to physically separate the upper 10 and lower 20 chambers, such that the upper chamber 10 thereby becomes an upper compartment 101 and the lower chamber 20 thereby becomes a lower chamber 102. The phase-changing separator 103 is in thermal contact with the upper 101 and lower 102 compartments. In this way, thermal energy generated in the upper compartment 101 can be transferred to the lower compartment 102 by the phase-changing separator 103, whereby at least some of the thermal energy transferred to the lower compartment 102 thermally decomposes at least some of the gas-generating composition 112.

It is to be expressly understood that after placement of the phase-changing separator 103, the upper 101 and lower 102 compartments, may, but need not, be completely isolated or sealed from one another; in some embodiments, there may be one or more gaps, passages, spaces, or voids (e.g. about a circumferential edge of the phase-changing separator 103) that allow gases or other materials to pass from the lower compartment 102, adjacent to a first face, side, or surface of the phase-changing separator 103, to the upper compartment 101, adjacent to a second face, side, or surface of the phase-changing separator 103, or vice versa. By way of non-limiting example, side walls 111b,c may be curved such that the container forming the body of the gas generator device 100 is cylindrical or approximately cylindrical, and the phase-changing separator 103 may be a disk having a diameter smaller than an interior diameter of the cylindrical container and supported by any suitable means (e.g. resting on catches or stops provided for that purpose inside the gas generator device 100, or directly on top of the gas-generating composition 112 or sealing element 113), such that product gas(es) formed by reaction of the gas-generating composition 112, or other materials, can pass from the lower compartment 102 to the upper compartment 101 (or vice versa) via an annular space between the circumferential edge of the phase-changing separator 103 and side walls 111b,c.

In some embodiments, the phase-changing separator 103 may be constructed principally of a combination or mixture of at least two different materials, such as a metal alloy. Non-limiting examples of such combinations and mixtures include steel and brass. The combination or mixture may be substantially homogeneous, or may be provided in a spatially varying form, i.e. where certain regions of the phase-changing separator 103 are particularly rich (or poor) in a selected component of the combination or mixture. Particularly, the use of a plate or sheet of steel, brass, or similar material as the phase-changing separator 103 may allow for “tuning” of the melting, vaporization, and/or sublimation characteristics to provide a desired effect; by way of non-limiting example, the phase-changing separator 103 can, in some embodiments, undergo an incomplete or partial phase change, i.e. wherein a portion of the separator undergoes a phase change while another portion of the separator remains in the solid state, which may provide various advantages and benefits as described throughout this disclosure.

As illustrated in FIG. 5C, after placement of the phase-changing separator 103 into the container to define and separate the upper 101 and lower 102 compartments, construction of the gas generator device 100 proceeds by placing a heat-generating composition 114, such as a thermite composition, into the upper compartment 102. Where the heat-generating composition 114 is a thermite composition, a metal oxide of the thermite composition may, but need not, be selected from the group consisting essentially of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations and mixtures thereof, and a metal of the thermite composition may, but need not, be selected from the group consisting of aluminum, magnesium, silicon, manganese, an alloy of magnesium and aluminum, and combinations and mixtures thereof. The thermite composition may, but need not, comprise more than one metal, more than one metal oxide, or both. In one configuration, the heat-generating composition 114 comprises a thermite composition that comprises a mixture of ferric oxide and aluminum. It is typical, especially when the heat-generating composition 114 is a thermite composition, to provide the heat-generating composition 114 either in the form of a powder or mixture of powders, or as a cast, bonded, or cemented sheet or other article, but it is to be appreciated that the heat-generating composition 114 can take any of a number of other suitable physical forms, including, by way of non-limiting example, pellets, sheets, tubes, rods, and fibers.

Optionally, a support element 115 may be placed in the container below the heat-generating composition 114 to hold the heat-generating composition 114 in place in the upper compartment 101; the support element 115, if provided, may be placed before placement of the heat-generating composition (for example, a heat-generating composition 114 in the form of powder, pellets, etc. may be poured or otherwise placed onto the support element 115), or, as illustrated in FIG. 5C, the support element 115 may be a scaffold or substrate onto which the heat-generating composition 114 is cast, bonded, or cemented prior to being placed in the container. In some embodiments, the support element 115 may be a relatively thin and/or flexible component, and/or may be constructed of material(s) having a relatively low melting, vaporization, and/or sublimation temperature, such that the support element 115 melts, vaporizes, sublimates, or otherwise disintegrates during operation of the gas generator device 100; one example of a suitable material for a support element 115 of this type is aluminum foil. It is to be expressly understood that some embodiments of the gas generator device 100 may omit the support element 115, in which case the heat-generating composition 114 may be in direct physical contact with and/or directly supported by the phase-changing separator 103, and in some embodiments the heat-generating composition 114 may even be cast, cemented, or bonded directly onto a top surface of the phase-changing separator 103, either before or after placement of the phase-changing separator 103 into the container.

As further illustrated in FIG. 5C, after placement of the heat-generating composition 114 into the upper compartment 101, construction of the gas generator device may further include provision of an igniter 104 and/or a top enclosure 111d comprising an outlet 107. The igniter 104 may cause the ignition of the heat-generating composition 114; in some configurations, a spark generated within the igniter 104 may initiate the ignition process, while in other configurations, the ignition process may be initiated by thermal energy generated within the igniter 104. The thermal energy provided within igniter 104 may be from a hot wire. In other configurations, the initiating energy within igniter 104 may be from flame. In other configurations, the initiating energy within the igniter 104 may be provided by friction. The igniter 104 may further comprise an ignition aperture in the upper compartment 101, which may be configured with a safety-delay switch system. The product gas(es) released from the gas-generating composition 112 may be released through outlet 107; in some embodiments, the outlet 107 may be interconnected with a heat exchanger 106 (not depicted in FIGS. 5A through 5C) that is configured to cool the product gas(es). Optionally, the outlet 107 (and/or heat exchanger 106, if provided) may comprise or be interconnected with one or more filters, sieves, traps, condensers, or other similar components to selectively remove an identified undesirable species from the product gas(es).

Referring now to FIG. 6, a gas generator device 100 substantially as depicted in any one or more of FIGS. 1, 3, 4, and 5C is shown. In the embodiment illustrated in FIG. 6, the gas generator device 100 is in fluid communication with an inflatable article 150. As shown, operation of the gas generator device 100 causes the product gas(es) to be released through outlet 107 into the inflatable article 150, thereby inflating the inflatable article 150. In some embodiments, the inflatable article 150 may be selected from the group consisting of a balloon (e.g. a meteorological balloon), a blimp, or a HIAD.

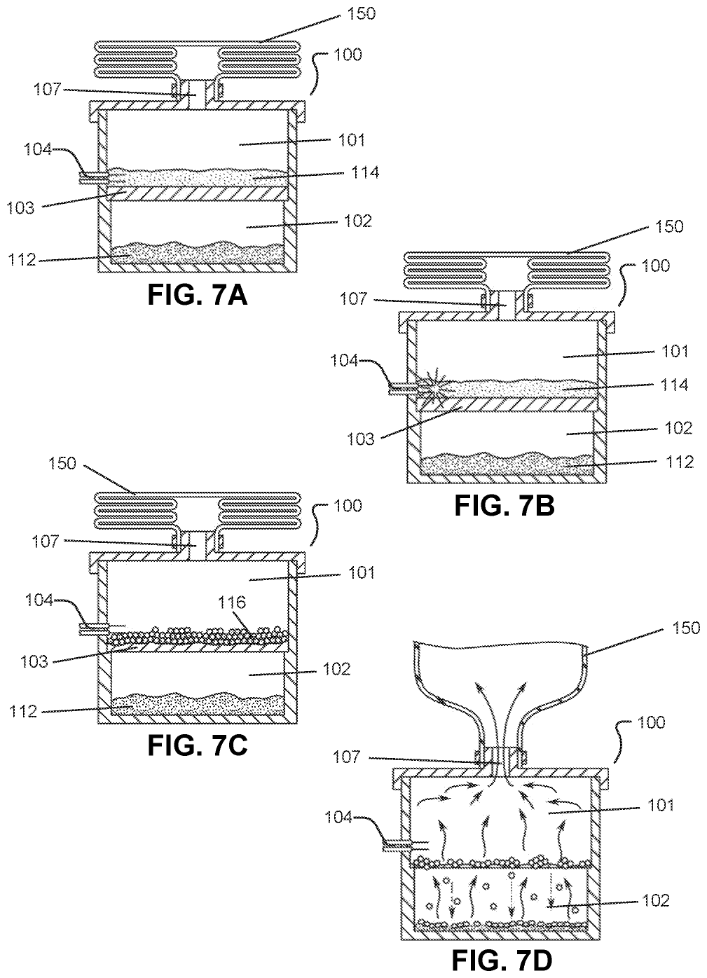

Referring now to FIGS. 7A through 7D, a non-limiting configuration of a gas generator device 100 is illustrated at various stages of reaction of the heat-generating composition 114 and gas-generating composition 112. Although the embodiment of the gas generator device 100 illustrated in FIGS. 7A through 7D is shown in association with an inflatable article 150, which is initially in a collapsed, deflated, or uninflated state (FIGS. 7A through 7C) and is inflated as a result of operation of the gas generator device 100 (FIG. 7D), it is to be expressly understood that gas generator devices 100 as depicted in FIGS. 7A through 7D may be provided for any suitable purpose and in association with any other suitable apparatuses, devices, and systems for which generation of a gas may be desired.

Prior to ignition of the heat-generating composition 114 (FIG. 7A), the phase-changing separator 103 is entirely in the solid state and acts as a rigid barrier between the upper 101 and lower 102 compartments, and therefore between the heat-generating 114 and gas-generating 112 compositions; it is to be expressly understood, however, that the upper 101 and lower 102 compartments, may, but need not, be completely isolated or sealed from one another, and that in some embodiments, there may be one or more gaps, passages, spaces, or voids (e.g. about a circumferential edge of the phase-changing separator 103) that allow gases or other materials to pass from the lower compartment 102, adjacent to a first face, side, or surface of the phase-changing separator 103, to the upper compartment 101, adjacent to a second face, side, or surface of the phase-changing separator 103, or vice versa.. In the illustrated embodiment, the support element 115 depicted in FIG. 5C is omitted (i.e. the heat-generating composition 114 is positioned directly on a top surface of the phase-changing separator 103), as is the sealing element 113 depicted in FIGS. 5A through 5C, but it is to be expressly understood that either or both of these elements may also be provided in certain embodiments. In operation, when generation of one or more product gas(es) is desired, the heat-generating composition 114 is ignited, in some embodiments by an igniter 104 in association with the upper compartment 101 (FIG. 7B).

After ignition (FIG. 7C), the heat-generating composition 114 begins to react and form reaction products and/or slags 116, and the heat generated by the reaction of the heat-generating composition 114 causes at least a portion of the phase-changing separator 103 to melt, vaporize, or sublimate; as a result, the reacting heat-generating composition 114 and hot reaction products/slags 116 may begin to “eat” or “burn” into the phase-changing separator 103 (depicted as a reduced thickness of the phase-changing separator 103 in FIG. 7C relative to FIGS. 7A and 7B). However, in many embodiments, including that depicted in FIG. 7C, the gas-generating composition 112 remains substantially unreacted at an early point in the reaction of the heat-generating composition 114, i.e. the phase-changing separator 103 provides the advantage and benefit of allowing the reaction of the heat-generating composition 114 to proceed to a significant degree of completion before reaction of the gas-generating composition 112 is initiated.

Finally, as reaction of the heat-generating composition 114 continues (FIG. 7D), further portions of the phase-changing separator 103 melt, sublimate, or vaporize as heat is transferred from the upper compartment 101 to the lower compartment 102, via the phase-changing separator 103, to initiate reaction of the gas-generating composition 112. As a result, some portions of the reaction products/slags 116 of the heat-generating composition 114 (e.g. those portions lying atop a completely melted, sublimated, or vaporized portion of the phase-changing separator 103) may fall through the phase-changing separator 103, while other portions of the reaction products/slags 116 of the heat-generating composition 114 (e.g. those lying atop a portion of the phase-changing separator that has undergone no, or incomplete/partial, melting, sublimation, or vaporization) may remain on top of the phase-changing separator 103. In some embodiments, the phase-changing separator 103 may be constructed with a chemical or structural composition, which may (but need not) be spatially varying, to engineer or “tune” the proportion of the reaction products/slags 116 that fall through to the lower compartment 102 and thereby come into direct contact with the gas-generating composition 112; by way of non-limiting example, certain areas, layers, portions or regions of the phase-changing separator 103 may have a higher (or lower) melting, sublimation, or vaporization temperature, a greater (or lesser) thickness, etc. than other areas, layers, portions, or regions. Meanwhile, as the gas-generating composition 112 reacts (e.g. a polymer and/or metal hydride in the lower compartment 102 decomposes), the product gas(es) evolved by this reaction flow from the lower compartment 102 into the upper compartment 101 (e.g. by diffusion through the phase-changing separator 103; by passage through holes or voids in the phase-changing separator 103, whether pre-fabricated or as a result of melting, sublimation, or vaporization of portions of the phase-changing separator 103; via an annular space between a circumferential edge of the phase-changing separator 103 and side walls of the gas generator device 100; by use of a port, vent, or pump; etc.), and then through outlet 107 and into the inflatable article 150 to inflate the inflatable article 150.

In some embodiments, there may be more than one upper compartment 101 and/or more than one lower chamber 20/lower compartment 102. It is to be expressly understood that the upper 101 and lower 102 compartments, may, but need not, be completely isolated or sealed from one another; in some embodiments, there may be one or more gaps, passages, spaces, or voids (e.g.

about a circumferential edge of the phase-changing separator 103) that allow gases or other materials to pass from the lower compartment 102, adjacent to a first face, side, or surface of the phase-changing separator 103, to the upper compartment 101, adjacent to a second face, side, or surface of the phase-changing separator 103, or vice versa. By way of non-limiting example, the container forming the body of the gas generator device 100 may be cylindrical or approximately cylindrical, and the phase-changing separator 103 may be a disk having a diameter smaller than an interior diameter of the cylindrical container and supported by any suitable means (e.g. resting on catches or stops provided for that purpose inside the gas generator device 100, or directly on top of the gas-generating composition 112 or sealing element 113), such that product gas(es) formed by reaction of the gas-generating composition 112, or other materials, can pass from the lower compartment 102 to the upper compartment 101 (or vice versa) via an annular space between the circumferential edge of the phase-changing separator 103 and side walls of the gas generator device 100.

Embodiments of the devices and methods disclosed herein may be directed to the thermal decomposition of any one or more polymers, such as polyethylene, polypropylene, polystyrene, trioxane, polyoxymethylene, and combinations, copolymers, and mixtures thereof. Additionally or alternatively, embodiments of the devices and methods disclosed herein may be directed to the thermal decomposition of any one or more metal hydrides, such as lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and combinations and mixtures thereof.

Embodiments of the devices and methods disclosed herein may be directed to the production of any one or more product gases, but particularly may be directed to the production of ethylene gas, and/or (either directly or by secondary thermal or catalytic decomposition of ethylene) hydrogen gas. Ethylene gas, or hydrogen gas, or the combination of ethylene and hydrogen gases may, in embodiments, generally make up at least about 75 mol %, more generally at least about 70 mol %, even more generally at least about 65 mol %, yet even more generally at least about 60 mol %, still yet even more generally at least about 55 mol %, still yet even more generally at least about 50 mol %, still yet even more generally at least about 45 mol %, still yet even more generally at least about 40 mol %, still yet even more generally at least about 35 mol %, still yet even more generally at least about 30 mol %, or still yet even more generally at least about 25 mol % of the total product gas content.

In embodiments of the devices and methods disclosed herein, the composition of the product gas(es) may be such that it is not necessary to provide additional heat or other (or, in some cases, any) energy inputs to maintain most or all of the product gas(es) in the desired gaseous state after formation of the gas. By way of non-limiting example, the product gas(es) may in some embodiments be passively or actively cooled to ambient or near-ambient temperatures (e.g. at least substantially, if not entirely, free of added heat or thermal energy relative to ambient conditions), without risk of undesirable condensation of product gas(es). In this way, the devices and methods disclosed herein may advantageously serve differing purposes relative to gas generation devices and methods of the prior art.

In some embodiments, the precise chemical composition or properties of the one or more product gas(es) are not a consideration, or at least are not as crucial a consideration, as the rate or amounts (whether molar or mass amounts) in which the product gas(es) can be generated; by way of non-limiting example, it may be desirable to produce as great a molar quantity of gas as possible to inflate an inflatable article to the greatest extent possible, since volume is directly related not to mass of the gas but to its molar quantity. In these applications, it may be desirable to cause the polymer and/or metal hydride to decompose in the first instance, and/or to cause one or more product gas(es) to undergo secondary decomposition, into as “small” (in molecular weight terms) a gas as possible to increase the volume of gas produced without requiring additional mass of materials. One such desirable “small” gas is hydrogen gas (H₂). Thus, in embodiments, a heat-generating composition may be provided that provides temperatures great enough to rapidly facilitate decomposition of, e.g., ethylene gas (produced, e.g., by decomposition of polyethylene) to hydrogen gas. In other embodiments, a catalyst may be provided in the compartment containing the polymer and/or metal hydride that catalyzes the decomposition of a product gas into hydrogen gas or another “small” gas.

In some embodiments, it may be necessary to minimize or eliminate byproducts, impurities, and other undesirable species in the product gas(es). However, limitations on the availability of a suitable polymer and/or metal hydride may necessitate the use of a polymer and/or metal hydride that is susceptible to the production of such byproducts, impurities, and undesirable species. By way of non-limiting example, higher hydrocarbons such as C4 hydrocarbons may be produced when decomposing polymers such as polyethylene, polypropylene, polystyrene, trioxane, or polyoxymethylene, which could be undesirable due to condensation in low-temperature applications. Thus, devices and systems of the present disclosure may include one or more filters, sieves, traps, condensers, or other similar components to selectively remove an identified undesirable species from the product gas(es). Such components can be provided in association with the compartment in which the product gas(es) is/are formed by decomposition of the polymer and/or metal hydride, or they can be provided in association with a separate compartment into which the one or more product gases flow after formation.

In some embodiments, it may be desirable to provide for further chemical processing of the one or more product gases. Particularly, it may be desirable to provide for subsequent chemical reaction of one or more product gases, e.g. gas production or gas reformation. In such embodiments, the devices and methods of the invention may employ a catalyst configured to facilitate such chemical processing of the one or more product gases. Such catalyst may be provided in any desired spatial arrangement (e.g. a fixed bed), and may be present either in the compartment in which the one or more product gases are formed (i.e. the compartment containing the polymer and/or metal hydride), or in a separate compartment configured to receive the one or more product gases.

In embodiments of the present disclosure, the gas-generating composition, i.e. the polymer and/or metal hydride, may be selected based on the identity of the gas or gases desired to be produced. By way of non-limiting example, where a gas desired to be produced is ethylene gas, polyethylene may be selected as the gas-generating composition. In some embodiments, the desired gas may be a secondary decomposition product, i.e. a gas that is produced by first thermally decomposing the gas-generating composition into an intermediate species and then further thermally or catalytically decomposing the intermediate species to the desired gas, and the gas-generating composition may be selected accordingly; by way of non-limiting example, where a desired gas is hydrogen gas, polyethylene may be selected as the gas-generating composition, and the gas generator device 100 may be configured to first decompose the polyethylene to ethylene gas and subsequently (due to, e.g., increased temperature or the presence of a catalyst) decompose the ethylene gas to hydrogen gas. Other polymers suitable for producing these or other product gases include polypropylene, polystyrene, trioxane, and polyoxymethylene.

In embodiments of the present disclosure, the polymer and/or metal hydride may be provided in any suitable physical form. By way of first non-limiting example, the polymer and/or metal hydride may be provided in a physical form comprising one or more pellets. By way of second non-limiting example, the polymer and/or metal hydride may be provided in a physical form comprising one or more sheets. By way of third non-limiting example, the polymer and/or metal hydride may be provided in a physical form comprising one or more tubes. By way of fourth non-limiting example, the polymer and/or metal hydride may be provided in a physical form comprising one or more rods. By way of fifth non-limiting example, the polymer and/or metal hydride may be provided in a physical form comprising one or more fibers. By way of sixth non-limiting example, the polymer and/or metal hydride may be provided in a physical form comprising one or more molded shapes or articles.

While the foregoing disclosure has in some cases focused on the production of gases in the context of inflating an inflatable article, it is to be expressly understood that the devices and methods of the disclosure are suitable to produce one or more product gases for any desired application. By way of first non-limiting example, the devices and methods of the disclosure may be used to fill or pressurize a cylinder, tank, or vessel, e.g. a storage cylinder or tank, with a desired gas. By way of second non-limiting example, the devices and methods of the disclosure may be used to produce a lifting gas to be used in, e.g., a buoyant vehicle or article such as a hot air balloon or a float. By way of third non-limiting example, the devices and methods of the disclosure may be used to produce a selected atmosphere within a volume, e.g. ethylene gas may be produced and used in a “ripening room” to accelerate the ripening of fruits and vegetables. These and other applications are within the scope of the present disclosure.

Several variations and modifications of the disclosure can be used. It would be possible to provide for some features of the disclosure without providing others.

The present disclosure, in various aspects, embodiments, and configurations, includes components, methods, processes, systems and/or apparatus substantially as depicted and described herein, including various aspects, embodiments, configurations, sub-combinations, and subsets thereof. Those of skill in the art will understand how to make and use the various aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and/or reducing cost of implementation.

The disclosure illustratively disclosed herein suitably may be practiced in the absence of any element which is not specifically disclosed herein. It is apparent to those skilled in the art, however, that many changes, variations, modifications, other uses, and applications of the disclosure are possible, and also changes, variations, modifications, other uses, and applications which do not depart from the spirit and scope of the disclosure are deemed to be covered by the disclosure, which is limited only by the claims which follow.

The foregoing discussion of the disclosure has been presented for purposes of illustration and description. The foregoing is not intended to limit the disclosure to the form or forms disclosed herein. In the foregoing Detailed Description, for example, various features of the disclosure are grouped together in one or more embodiments for the purpose of streamlining the disclosure. The features of the embodiments of the disclosure may be combined in alternate embodiments other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the description of the disclosure has included description of one or more embodiments and certain variations and modifications, other variations, combinations, and modifications are within the scope of the disclosure, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A device, comprising:
at least one separator, at least a portion of which can undergo a phase change under conditions occurring in the device;
a pyrotechnic composition, proximate to a first surface of the at least one separator; and
at least one gas generating composition comprising a metal hydride, proximate to a second surface of the at least one separator, wherein the at least one separator is positioned between the pyrotechnic and gas generating compositions,
wherein at least a portion of the at least one separator is configured to undergo a phase change, using heat generated by a reaction of the pyrotechnic composition.

2. The device of claim 1, wherein the at least one separator comprises a metal.

3. The device of claim 1, wherein the at least one separator comprises at least first and second layers, wherein a material of the first layer is different from a material of the second layer.

4. The device of claim 1, wherein the at least one separator comprises a mixture of at least two different materials.

5. The device of claim 1, wherein the pyrotechnic composition is a thermite composition comprising a mixture of a metal fuel and a metal oxide oxidizer that undergoes an exothermic reduction-oxidation reaction when ignited by heat.

6. The device of claim 1, wherein the at least one separator is configured such that at least a portion of the pyrotechnic composition or its reaction products and at least a portion of the gas generating composition are in direct physical contact following the phase change.

7. The device of claim 1, further comprising an igniter configured to ignite the pyrotechnic composition.

8. A process, comprising:
initiating reaction of a pyrotechnic composition consisting essentially of a metal oxide and a metal to release thermal energy;
causing at least a portion of at least one separator to undergo a phase change, using thermal energy released by the reaction; and
decomposing, using the thermal energy released by the reaction, at least some of one or more metal hydrides to release hydrogen gas.

9. The process of claim 8, wherein the at least one separator comprises a metal.

10. The process of claim 8, wherein the at least one separator comprises at least first and second layers, wherein a material of the first layer is different from a material of the second layer.

11. The process of claim 8, wherein the at least one separator comprises a mixture of at least two different materials.

12. The process of claim 8, wherein the at least one separator is configured such that at least a portion of the pyrotechnic composition or its reaction products and at least a portion of the one or more metal hydrides are in direct physical contact following the phase change.

13. An inflatable device, comprising:
an inflatable article; and
a self-contained hydrogen generator:
a) interconnected to the inflatable article;
b) configured to inflate the inflatable article; and
c) having at least one thermal separator positioned between and in thermal contact with:
i) a thermite composition comprising a metal oxide and a metal; and
ii) at least one gas generating composition comprising a metal hydride,
wherein at least a portion of the at least one thermal separator is configured to undergo a phase change, using heat generated by a reaction of the thermite composition.

14. The inflatable device of claim 13, wherein the at least one thermal separator comprises a metal.

15. The inflatable device of claim 13, wherein the at least one thermal separator comprises at least first and second layers, wherein a material of the first layer is different from a material of the second layer.

16. The inflatable device of claim 13, wherein the at least one thermal separator comprises a mixture of at least two different materials.

17. The inflatable device of claim 13, wherein the at least one separator is configured such that at least a portion of the thermite composition or its reaction products and at least a portion of the gas generating composition are in direct physical contact following the phase change.

18. The inflatable device of claim 13, further comprising an igniter configured to ignite the thermite.

19. A gas generator device, comprising:
a heat-generating composition;
a gas generating composition comprising a polymer; and
at least one separator,
wherein the heat-generating composition is proximate to a first surface of the at least one separator and the gas-generating composition is proximate to a second surface of the at least one separator, and
wherein at least a portion of the at least one separator is configured to undergo a phase change, using heat generated by a reaction of the heat-generating composition.

20. The gas generator device of claim 19, wherein the at least one separator comprises a metal.

21. The gas generator device of claim 19, wherein the at least one separator comprises at least first and second layers, wherein a material of the first layer is different from a material of the second layer.

22. The gas generator device of claim 19, wherein the at least one separator comprises a mixture of at least two different materials.

23. The gas generator device of claim 19, wherein the polymer is selected from the group consisting of polyethylene, polypropylene, polystyrene, trioxane, polyoxymethylene, and combinations and mixtures thereof.

24. The gas generator device of claim 19, wherein the heat-generating composition is a thermite composition comprising a mixture of a metal fuel and a metal oxide oxidizer that undergoes an exothermic reduction-oxidation reaction when ignited by heat.

25. The gas generator device of claim 19, wherein the at least one separator is configured such that at least a portion of the heat-generating composition or its reaction products and at least a portion of the gas-generating composition are in direct physical contact following the phase change.

26. The gas generator device of claim 19, further comprising an igniter configured to ignite the heat-generating composition.

27. A method for generating at least one product gas, comprising:
initiating reaction of a heat-generating composition to release thermal energy;
using a portion of the thermal energy to cause a phase change in at least a portion of at least one separator positioned between the heat-generating composition and a polymer; and
decomposing, with thermal energy released by the reaction and transferred to the polymer, at least some of the polymer to release the at least one product gas.

28. The method of claim 27, wherein the at least one separator comprises a metal.

29. The method of claim 27, wherein the at least one separator comprises at least first and second layers, wherein a material of the first layer is different from a material of the second layer.

30. The method of claim 27, wherein the at least one separator comprises a mixture of at least two different materials.

31. The method of claim 27, wherein the polymer is selected from the group consisting of polyethylene, polypropylene, polystyrene, trioxane, polyoxymethylene, and combinations and mixtures thereof

32. The method of claim 27, wherein the heat-generating composition is a thermite composition comprising a mixture of a metal fuel and a metal oxide oxidizer that undergoes an exothermic reduction-oxidation reaction when ignited by heat.

33. The method of claim 27, wherein the at least one separator is configured such that at least a portion of the heat-generating composition or its reaction products and at least a portion of the polymer are in direct physical contact following the phase change.
